(19) United States
(12) Patent Application Publication
(10) Pub. No.: US 2025/0161892 A1
(43) Pub. Date: May 22, 2025

(54) POD VENTURI

(71) Applicant: KOHLER MIRA LIMITED, Cheltenham (GB)

(72) Inventor: Robin Whitfield, Cheltenham (GB)

(21) Appl. No.: 18/947,734

(22) Filed: Nov. 14, 2024

Related U.S. Application Data
(60) Provisional application No. 63/599,596, filed on Nov. 16, 2023.

(51) Int. Cl. B01F 25/312

(52) U.S. Cl. CPC B01F 25/31241; B01F 25/3125

(57) ABSTRACT

A venturi is provided herein that includes a tubular passageway, a pod, a first entry point, and a second entry point. The pod may be positioned and contained within the tubular passageway. The first entry point may introduce a first media into the venturi, and a second entry point may introduce a second media into the venturi. The first media and second media may be any media, including fluid or gas. The first media may mix with the second media to develop a mixed media, and the mixed media may flow around the pod. The pod may translate axially within the tubular passageway via a translation rod and a spring. The spring may cause the pod to translate axially based on a pressure of the fluid entering the venturi.

### CROSS-REFERENCE TO RELATED APPLICATIONS

The present application claims priority to U.S. Provisional Patent Application No. 63/599,596, filed Nov. 16, 2023, entitled, “POD VENTURI,” the entire contents of which are hereby incorporated by reference.

### BACKGROUND

A venturi may be used for mixing different media (e.g., fluids, gases, etc.). One example of such an existing venturi is shown in FIG. 1. A venturi 1 may include a first tubular passageway 5, which may be circular, through which a first media 10 may flow. The first tubular passageway 5 may gradually reduce in cross-sectional area. This reduction may speed up the flow rate of the first media 10 through a constriction 15. At the narrowest point of the constriction 15 where the first media 10 may be travelling at its maximum velocity, which may be located at line 20, a pressure drop may be created. A second media 25 may be introduced via intake 30 at or near the constriction 15. The second media 25 may mix with the first media 10 into a mixed media 35. The mixed media 35 may exit through a second tubular passageway 40. The cross-sectional area of the second tubular passageway 40 may increase as it gets further from the constriction 15.

As shown in FIG. 2, the existing venturi 1 may have a media path 45. This media path 45 may lead to a reduced flow rate of the media. This reduced flow rate may lead to issues in flow sensitive applications (e.g., showers). Further, traditional venturis require a narrow range of pressures between which they may effectively mix various medias (e.g., fluid, gases, etc.). If the pressure is too low, then the induced pressure drop through the constriction may not be sufficient to draw in a second media. If the pressure is too high, then the venturis may experience chaotic flow with various negative effects (e.g., media being ejected from the intake 30).

Traditional venturis may require specific tuning for specific applications. For example, a traditional venturi may be tuned to fit a specific showerhead handset, and as such, that venturi may not be used for other handsets.

### BRIEF DESCRIPTION OF DRAWINGS

FIG. 1 is a perspective view of a prior art venturi.

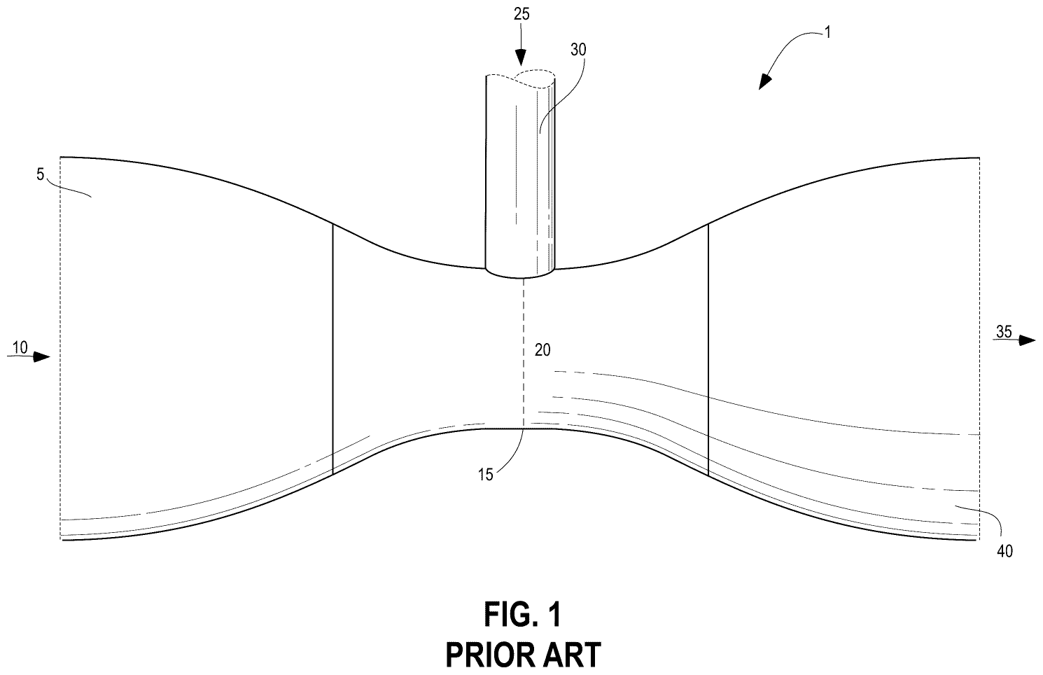

FIG. 2 is a cross-sectional view of media flow in the venturi of FIG. 1.

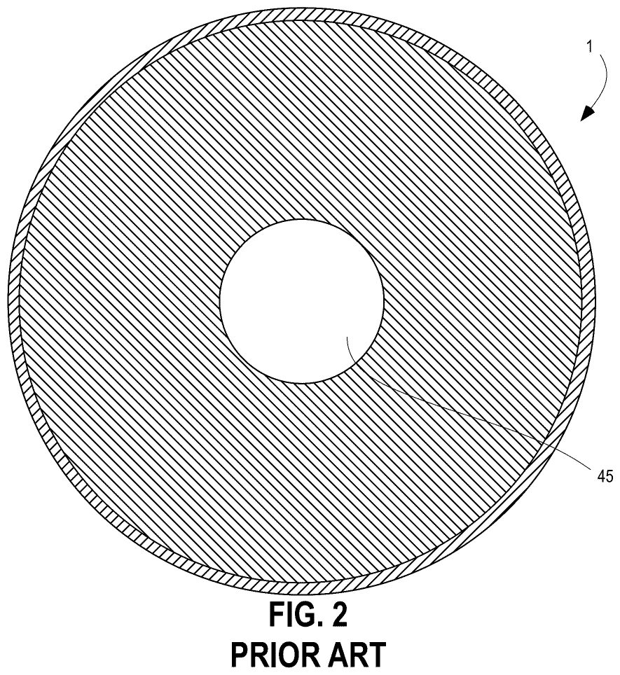

FIG. 3 is a cross-sectional view of a first example venturi.

FIG. 4 is a cross-sectional view of media flow in the venturi of FIG. 3.

FIG. 5 is a first cross-sectional view of a second example venturi.

FIG. 6 is a second cross-sectional view of the venturi of FIG. 5.

FIG. 7 is a third enlarged cross-sectional view of the venturi of FIGS. 5 and 6.

FIG. 8 is a cross-sectional view of a third example venturi.

FIG. 9 is a cross-sectional view of a fourth example venturi.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The venturis as described herein may be attached to, connected to, contained within, or integrated with systems and ablutionary fittings. The venturis as described herein may be attached to, connected to, contained within, or integrated with, for example, handsets and showerheads and other devices. The venturis may adjust themselves based on media pressure associated with such devices. The venturis may operate mechanically with or without a power supply.

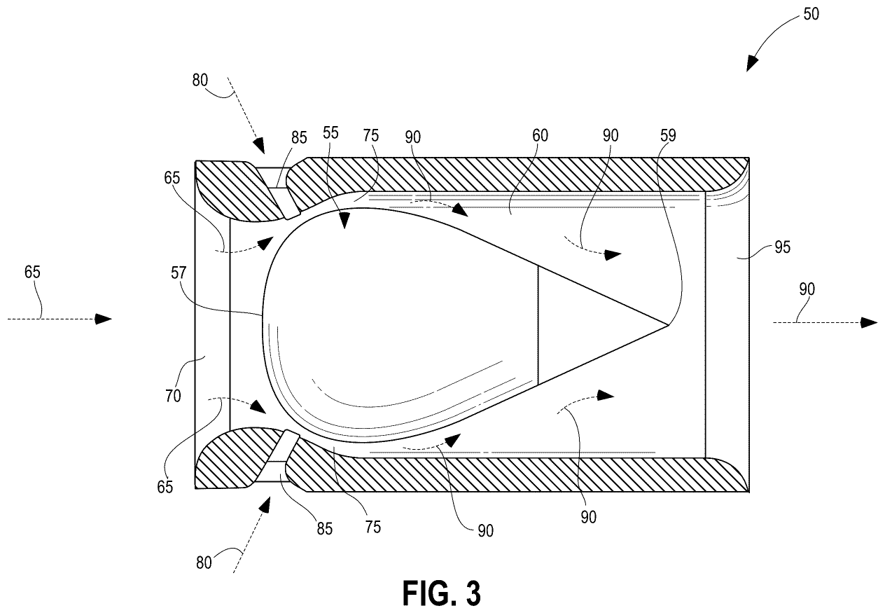

Turning first to FIG. 3, a venturi 50 may include a central pod 55, which may be substantially teardrop shaped. The venturi 50 may be any suitable or desired size or shape. The central pod 55 may include a bulbous end portion 57 at one end of the pod 55 and an end point 59 at one end of the pod (which may be substantially opposite the bulbous end portion 57). The central pod 55 may be placed within a tubular passageway 60 and may be held in place within the tubular passageway 60 via a plurality of fins (not illustrated), though alternative means for holding the central pod 55 substantially static within the tubular passageway 60 are envisioned.

When using the pod 55, a first media 65 may flow into the tubular passageway 60 at a first entry point 70. The first media 65 may be any form of media (e.g., fluid, gas, etc.). As one example, the first media 65 may be water. The first media 65 may flow around the pod 55, rather than through the center of the pod 55 and the tubular passageway 60. At a constriction point 75 upstream in the tubular passageway 60, a pressure drop may be induced, and the pressure drop may draw in a second media 80, which may be any form of media (e.g., fluid, gas, etc.), through a second entry point 85. The second media 80 may be the same media as the first media 65. As one example, the second media 80 may be air. As another example, the first media 65 and the second media 80 may both be water.

Although not illustrated, there may be several second entry points 85 in the venturi 50. The first media 65 and second media 80 may mix together to form the mixed media 90. The mixed media 90 may flow out of the tubular passageway 60 at exit point 95. When the second media 80 is mixed with the first media 65 to form the mixed media 90, the mixed media 90 may exit the venturi 50 with an increased pressure, as opposed to media that does not have mixed-in media (e.g., gas or other fluid). As one example, when the mixed media 90 is water mixed with air, the mixed media 90 may have an increased pressure as compared to the pressure of water alone. As one example, the first media may have a first pressure, the second media may have a second pressure, and the mixed media may have a third pressure. The third pressure may be greater than each of the first pressure and the second pressure, and as such, the mixed media may have a higher pressure than the pressure of the first and second media.

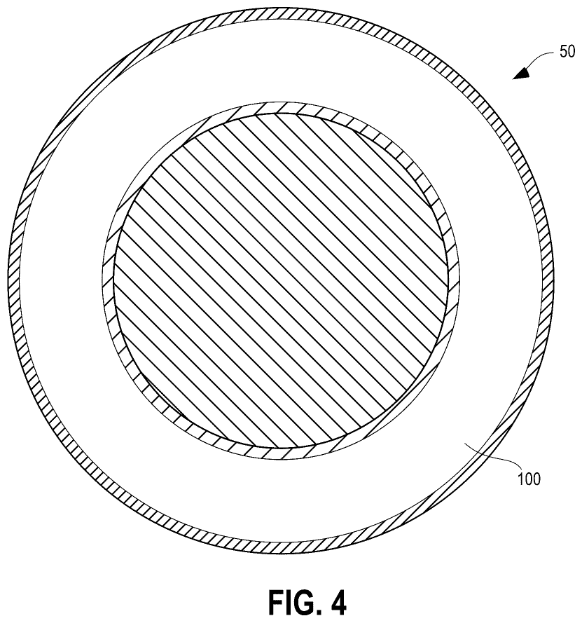

The manner of flow around the pod 55 may improve the flow of mixed media 90. The mixed media 90 may have an increased cross-sectional area for flow, as illustrated by media path 100 in FIG. 4. Media path 100 may enable a higher flow rate of the media through the venturi 50.

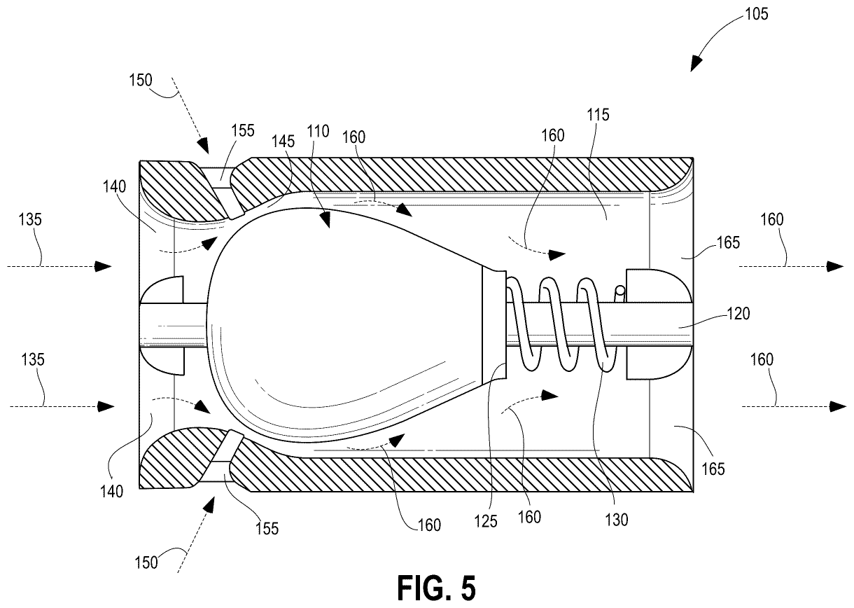

Turning now to FIG. 5, an alternatively constructed venturi 105 may include a central pod 110 that, unlike the central pod 55 of the venturi 50, may translate axially within a tubular passageway 115. Such translation may be variable, and it may allow for variable media flow throughout the venturi 105. A translation rod 120 may be attached to, or integrally formed with, the pod 110. The translation rod 120 may be positioned through a center portion 125 of the pod 110. Translation of the pod 110 may be operated by a spring 130 connected to the translation rod 120. The spring 130 may adjust based on pressure of a first media 135 that enters the venturi 105 via first entry points 140.

The spring 130 of the pod 110 may be activated due to pressure from flow of the first media 135. The spring 130 may be retracted in such a way that the pod 110 is in an open position. When in an open position, at constriction point 145, a pressure drop may be induced, and such pressure drop may draw in a second media 150, which may be gas, through a second entry point 155. Although not illustrated, there may be several second entry points 155 in the venturi 105. As discussed with reference to FIG. 3, the first media 135 and second media 150 may mix to form mixed media 160. The mixed media 160 may exit the venturi 105 via exit points 165.

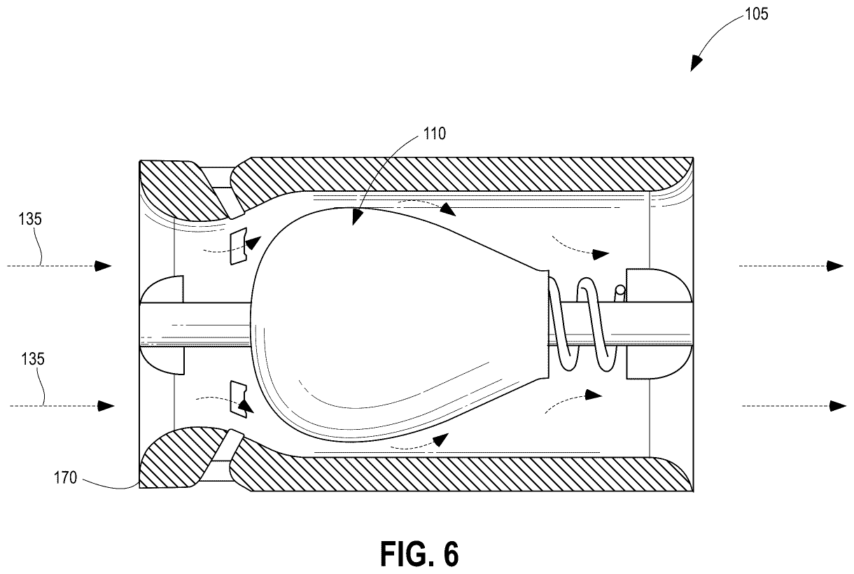

As illustrated in FIG. 6, the pod 110 may be further from a first end 170 of the venturi 105 than the pod 110 of FIG. 5. This may be dependent upon a pressure of the first media 135, and the pod 110 may be further translated because the first media 135 has a higher pressure than the first media 135 of FIG. 5.

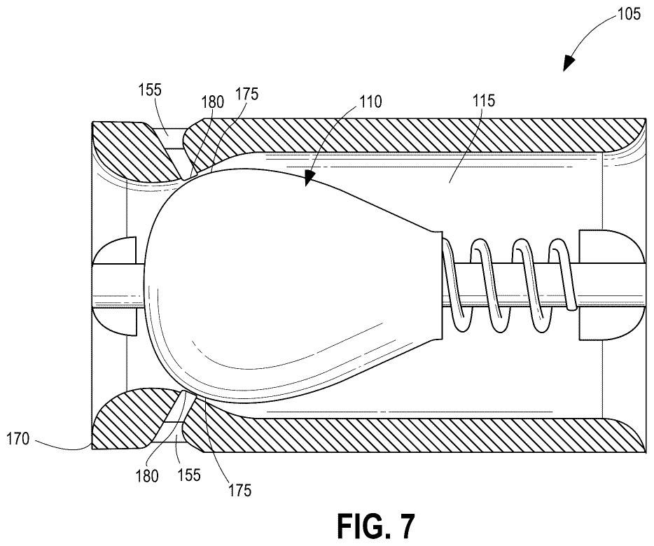

Turning now to FIG. 7, when there is no media pressure (i.e., no media flowing into the venturi 105), the pod 110 may be in a closed position, which may be at or near the first end 170. In the closed position, side portions 175 of the pod 110 may abut side portions 180 of the tubular passageway 115. The closed position may block the second entry points 155, which may diminish intake of media (e.g., fluid, gas, etc.) into the venturi 105. When in a closed position, no media may flow through the venturi 105. When the venturi 105 is attached to a handset, this closed position may aid in preventing drain-down of fluid from the handset.

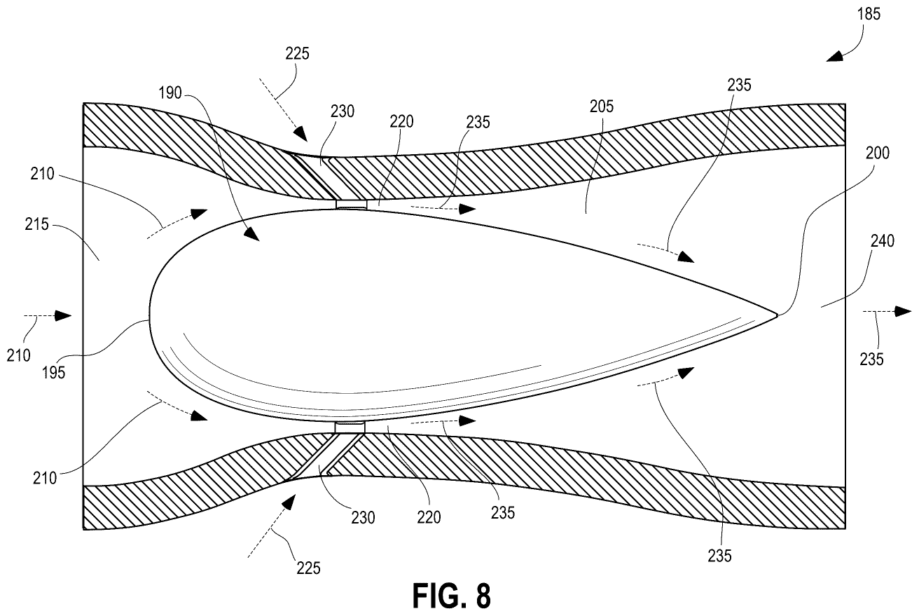

As discussed above with reference to FIG. 3, the venturis as described herein may be any suitable or desired size and/or shape. As illustrated in FIG. 8, a venturi 185 (which may be similar to venturi 50) may include a central pod 190, which may be substantially teardrop shaped. The central pod 190 may include a bulbous end portion 195 at one end of the pod 190 and an end point 200 at one end of the pod (which may be substantially opposite the bulbous end portion 195). The central pod 190 may be placed within a tubular passageway 205 and may be held in place within the tubular passageway 205 via a plurality of fins (not illustrated), though alternative means for holding the central pod 190 substantially static within the tubular passageway 205 are envisioned.

When using the pod 190, a first media 210 may flow into the tubular passageway 205 at a first entry point 215. The first media 210 may be any form of media (e.g., fluid, gas, etc.). As one example, the first media 210 may be water. The first media 210 may flow around the pod 190, rather than through the center of the pod 190 and the tubular passageway 205. At a constriction point 220 upstream in the tubular passageway 205, a pressure drop may be induced, and the pressure drop may draw in a second media 225, which may be any form of media (e.g., fluid, gas, etc.), through a second entry point 230. The second media 225 may be the same media as the first media 210. As one example, the second media 225 may be air. As another example, the first media 210 and the second media 225 may both be water.

Although not illustrated, there may be several second entry points 230 in the venturi 185. As discussed with reference to FIG. 3, the first media 210 and second media 225 may mix to form mixed media 235. The mixed media 235 may exit the venturi 185 via exit points 240. The manner of flow around the pod 190 may improve the flow of mixed media 235. The size and shape of the venturi 185 may contribute to reduced drag and turbulence as compared to other venturis, which may aid in optimizing a pressure drop between the first and second entry points 215, 230 and the exit points 240 of the venturi 185.

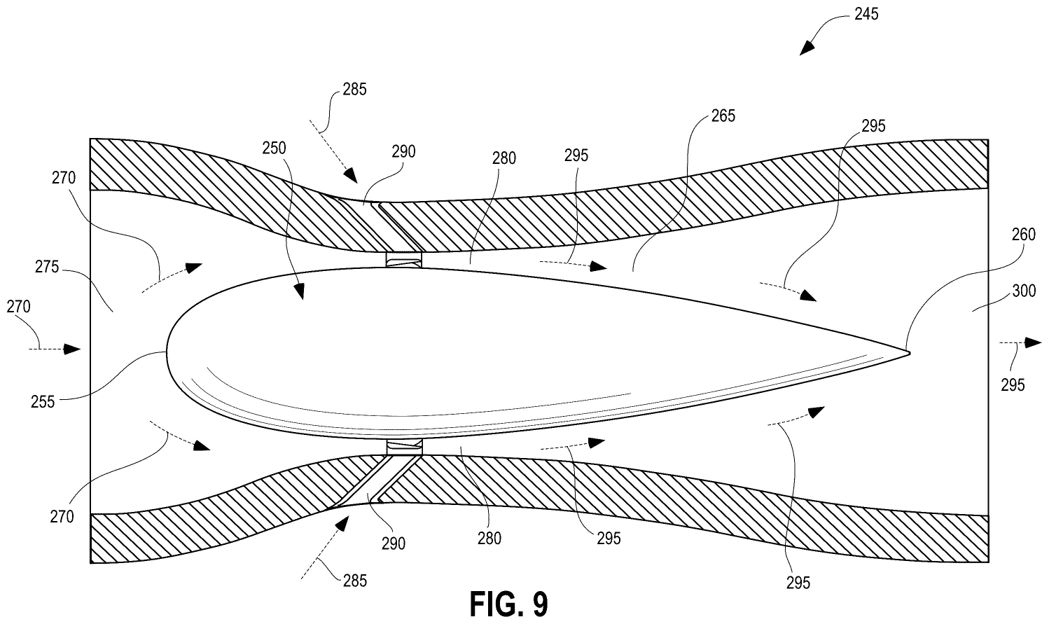

As illustrated in FIG. 9, a venturi 245 (which may be similar to venturi 50 or venturi 185, as discussed above) may include a central pod 250, which may be substantially teardrop shaped. The central pod 250 may include a bulbous end portion 255 at one end of the pod 250 and an end point 260 at one end of the pod (which may be substantially opposite the bulbous end portion 255). The central pod 250 may be placed within a tubular passageway 265 and may be held in place within the tubular passageway 265 via a plurality of fins (not illustrated), though alternative means for holding the central pod 250 substantially static within the tubular passageway 265 are envisioned. When using the pod 250, a first media 270 may flow into the tubular passageway 265 at a first entry point 275. The first media 270 may be any form of media (e.g., fluid, gas, etc.). As one example, the first media 270 may be water. The first media 270 may flow around the pod 250, rather than through the center of the pod 250 and the tubular passageway 265. At a constriction point 280 upstream in the tubular passageway 265, a pressure drop may be induced, and the pressure drop may draw in a second media 285, which may be any form of media (e.g., fluid, gas, etc.), through a second entry point 290. The second media 285 may be the same media as the first media 270. As one example, the second media 285 may be air. As another example, the first media 270 and the second media 285 may both be water.

Although not illustrated, there may be several second entry points 290 in the venturi 245. As discussed with reference to FIG. 3, the first media 270 and second media 285 may mix to form mixed media 295. The mixed media 295 may exit the venturi 245 via exit points 300. The manner of flow around the pod 250 may improve the flow of mixed media 295. The size and shape of the venturi 245 may contribute to reduced drag and turbulence as compared to other venturis, which may aid in optimizing a pressure drop between the first and second entry points 275, 290 and the exit points 300 of the venturi 245.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A venturi comprising:
a tubular passageway;
a pod positioned within the tubular passageway;
a first entry point that introduces a first media into the venturi; and
a second entry point that introduces a second media into the venturi;
wherein the first media mixes with the second media to develop a mixed media; and
wherein the mixed media flows around the pod.

2. The venturi of claim 1, wherein the pod translates axially within the tubular passageway, the pod including:
a translation rod attached to a center portion of the pod; and
a spring attached to the translation rod.

3. The venturi of claim 2, wherein the spring causes the pod to translate axially based on a pressure of the first media entering the venturi.

4. The venturi of claim 1, wherein the pod is static within the tubular passageway and is held in place via a plurality of fins.

5. The venturi of claim 1, wherein the first media is fluid.

6. The venturi of claim 1, wherein the second media is gas.

7. The venturi of claim 1, wherein the first media has a first pressure, the second media has a second pressure, and the mixed media has a third pressure.

8. The venturi of claim 7, wherein the third pressure is greater than each of the first pressure and the second pressure.

9. A system comprising:
an ablutionary fitting; and
a venturi, wherein the venturi is one of attached to, connected to, contained within, or integrated with the ablutionary fitting, the venturi including:
a tubular passageway;
a pod positioned within the tubular passageway;
a first entry point that introduces a first media into the venturi; and
a second entry point that introduces a second media into the venturi;
wherein the first media mixes with the second media to develop a mixed media; and
wherein the mixed media flows around the pod.

10. The system of claim 9, wherein the mixed media exits the system via the ablutionary fitting.

11. The system of claim 9, wherein the pod translates axially within the tubular passageway, the pod including:
a translation rod attached to a center portion of the pod; and
a spring attached to the translation rod.

12. The system of claim 11, wherein the spring causes the pod to translate axially based on a pressure of the first media entering the venturi.

13. The system of claim 9, wherein the pod is static within the tubular passageway and is held in place via a plurality of fins.

14. The system of claim 9, wherein the first media is fluid.

15. The system of claim 9, wherein the second media is gas.

16. The system of claim 9, wherein the first media has a first pressure, the second media has a second pressure, and the mixed media has a third pressure, and wherein the third pressure is greater than each of the first pressure and the second pressure.

17. A venturi comprising:
a tubular passageway;
a pod positioned within the tubular passageway, wherein the pod translates axially within the tubular passageway;
a first entry point that introduces a fluid into the venturi; and
a second entry point that introduces a gas into the venturi;
wherein the fluid mixes with the gas to develop a mixed media.

18. The venturi of claim 17, the pod including:
a translation rod attached to a center portion of the pod; and
a spring attached to the translation rod.

19. The venturi of claim 18, wherein the spring causes the pod to translate axially based on a pressure of the fluid entering the venturi.

20. The venturi of claim 17, wherein the fluid has a first pressure, the gas has a second pressure, and the mixed media has a third pressure, and wherein the third pressure is greater than each of the first pressure and the second pressure.
